(19) United States
(12) Patent Application Publication
(10) Pub. No.: US 2013/0060575 A1
(43) Pub. Date: Mar. 7, 2013

(54) INTERACTIVE WEB-BASED PRESCRIPTION SYSTEM AND METHOD

(71) Applicant: Christopher NEE, Las Vegas, NV (US)

(72) Inventor: Christopher NEE, Las Vegas, NV (US)

(21) Appl. No.: 13/589,389

(22) Filed: Aug. 20, 2012

Related U.S. Application Data
(60) Provisional application No. 61/530,590, filed on Sep. 2, 2011.

(51) Int. Cl. G06Q 50/22

(52) U.S. Cl. 705/2

(57) ABSTRACT

Systems and methods for facilitating electronic prescriptions and the dispensation of medications subject to prior authorization and/or adherence to a pre-established formulary. A web-based interactive system is established whereby all entities responsible for the prescription event, namely, the prescribing physician, pharmacist/pharmacy and payer/authorizing entity are kept in direct communication with one another via a conventional, secure communications link. All pertinent information regarding the prescription, as well as the patient, is made available to all entities and further, all information associated with a particular formulary is uploaded and made available to the prescribing physician and pharmacist for quick reference as the whether or not a given medication is preapproved. The systems and methods of the present invention are exceptionally effective and efficient, and can be readily utilized with all medications designated as either Part B or Part D per the United States' Medicare healthcare administration system.

### CROSS-REFERENCE TO RELATED APPLICATIONS

The present patent application claims priority to Provisional Patent Application Ser. No. 61/530,590, entitled INTERACTIVE WEB-BASED PRESCRIPTION SYSTEM AND METHOD, filed on Sep. 2, 2011, all of the teachings of which are incorporated herein by reference.

### STATEMENT RE: FEDERALLY SPONSORED RESEARCH/DEVELOPMENT

Not Applicable

### BACKGROUND

The present invention is directed to methods for facilitating and significantly increasing the efficiency of processes by which medications are prescribed and dispensed, subject to third party payer approval, that further facilitates communication and interaction amongst all affected parties associated with the prescription event, namely, physicians, pharmacies, third party payers and patients. The present invention is also directed to web-based systems for facilitating such interaction and prescribing events.

Today, the “healthcare problem” centers mainly around the time after the doctor hands a prescription to the patient. In this regard, once a prescription leaves a doctor's hands, doctors typically are unaware of whether or not patients are getting their refills in time, whether or not the drugs prescribed are covered by payers, or if the prescriptions were even filled at all. Currently, once the prescription leaves the doctors hands and reaches the pharmacy, the pharmacists are unaware of the diagnosis. There can also be a great deal of confusion following the prescribing event concerning needed prior-authorization, denial of coverage, etc.

Currently available electronic prescription (eRx) programs on the market are primarily designed to be prescriber-centric. That is, every process is geared towards how a physician prescribes and then forwarding that prescribed medication prescription to a third party which then the third party forwards the prescription to the prescriber-designated or patient-designated pharmacy. Exemplary of such programs include those sold and distributed by SureScripts of Arlington, Va.

Such currently available programs, however, are very inefficient in that there is a rigorous, specific path for performing the specific functions. Any changes to that path lead to added time for either or both the prescriber or pharmacy to have to clarify those alternatives. Further, since prescribers and pharmacies are often dictated by health plans/payers for many of the features, such as formularies, prior authorizations, and specific pharmacies (mail-orders, etc.), this can lead to delays in patient care and added cost to the process.

Along these lines, it is common practice for insurance payers to use the formulary process to provide a listing of medications from which it will pay as part of the benefit they provide to patients. The way insurance payers “enforce” the payment of “formulary” medications is when the prescription is processed by the pharmacy through a Pharmacy Benefit Management (PBM) for patient and medication verifications. If the medication is on the formulary, then the PBM will allow for the process to continue for payment. If the medication is not on the formulary, then the patient has a choice to contact the prescriber for another prescription for a formulary medication or pay the entire cost of the original medication on their own.

The current process is cumbersome and confusing in that the prescriber often does not have ready access to what is on a particular insurance formulary. Even in today's electronic medical records and prescription process, prescribers are often unable to access the latest in formulary selections. In fact, the majority of the time prescribers are only made aware of formulary decisions when the pharmacy processes the medication to the PBM.

Another setback of current eRx systems is their inability to incorporate the electronic prescription of office-based injectables. As a result of this shortcoming, for medication regimens that require both regular medication and office-based injectables (e.g. oncology treatment), a doctor may send out a list of prescriptions to a regular pharmacy to find out that they have only filled two out of the five necessary medications for the treatment because three of those medications are office-based injectables (usually only sold at specialty pharmacies) and therefore required prior-authorization.

As such, there is a substantial need in the art for an electronic, interactive and web-based mechanism by which medications can be prescribed and dispensed subject to third party payer authorization that enables all entities associated with the prescription event, namely, physicians, pharmacists/pharmacies, third party payer and the patient to all have access to communicate with one another and thus eliminate the substantial inefficiencies associated with current electronic prescription practices. There is a further need in the art for a mechanism by which any type of prior authorization necessary as a requirement prior to dispensation of a medication can be secured in a manner that is far more efficient and timely than prior art practices. There is still further a need in the art for such a mechanism that is user friendly, can be readily deployed utilizing existing web-based technology, is substantially cost effective and can be readily integrated for any type of formulary system and in particular the Medicare healthcare administration system, and in particular may be utilized to facilitate the dispensation of drugs categorized as either Part B or Part D of the United States' Medicare healthcare delivery system.

### BRIEF SUMMARY

The present invention specifically addresses and alleviates the above-identified deficiencies in the art. Specifically, the present invention is directed to an interactive, web-based electronic prescription system whereby medications can be prescribed and dispensed subject to third party payer approval whereby all affected parties are operatively in communication with one another and can resolve any and all issues potentially complicating the prescription process. Unlike prior art electronic systems, the systems and methods of the present invention integrates every aspect of healthcare, namely, the physician prescribers, payers, patients and pharmacies, that provide for instant communication amongst all parties to eliminate inefficiencies and cost over-runs that are commonplace per prior art electronic prescription systems and methods.

In this regard, the systems and methods of the present invention eliminate the need for third party intermediaries but instead allows all involved entities to communicate with one another via a central platform with all aspects of the prescription event being documented and accessible to all affected parties from the time of prescription to the ultimate dispensation, regardless of pharmacy. Indeed, the systems and methods of the present invention are exceptionally effective at and facilitating the dispensation of drugs categorized as either Part B or Part D of the United States' Medicare healthcare delivery system. Moreover, it is further expressly contemplated that the systems and methods of the present invention will be exceptionally effective in streamlining the prescription and dispensation of pharmaceuticals adhering to a particular formulary whereby certain drugs in certain categories are pre-approved, as well as can expedite the prescription and dispensation of pharmaceuticals to be subject to an insurance payer's approval or denial. Alternatively, the dispensation of pharmaceuticals may be subject to prior authorization, which can be integrated as part of the systems and methods of the present invention.

The systems and methods of the present invention are further operative to facilitate communication between all pertinent parties associated with the prescription dispensation of pharmaceuticals. For example, the electronic prescribing system and methods disclosed herein show pharmacists the health plan group coverage code, the diagnosis of the patient and gives the pharmacists access to patient notes, such as known allergies, past medical records, and other pertinent information. This consequently allows pharmacists the ability to better counsel the patient on how to take their medication on a more personal basis. Pharmacists can also notify doctors if a patient is due for a refill, which doctors can instantly approve or deny with notes. This simple communication keeps medical responsibility with doctors and pharmacists, instead of other eRx systems that make the patients (who usually have little or no medical expertise) initiate their own refills. The present invention thus appropriates medical responsibility back to the medical professionals in order to improve the quality of care through improving doctor-pharmacy communication. This unique messaging system thus brings doctors and pharmacists together to work on treating their patients. While other eRx companies are so complicated or expensive that only doctors or pharmacists (but usually not both) will have their programs installed making them pointless anyway, the systems and methods discussed herein are easy to access and to start using so that doctors and pharmacists both will have no trouble transitioning. Lastly, the system also provides for patient access to all medication history. Currently, most patient-based medication history programs (e.g., FollowMyHealth, a product of Jardogs, LLC of Springfield, Ill.) require the patient to input the medication history into the program. This could be cumbersome and potentially dangerous if input error occurs. The current system allows for direct display of patient medication history into a patient portal so that patients can access and provide certain functions to healthcare professionals such as asking the pharmacy to refill specific prescriptions, etc.

To achieve those objectives, there is provided an interactive, web-based prescription and dispensation system whereby all entities associated with the prescription event, and in particular the prescribing physician, pharmacist/pharmacy and third party payer, are operatively linked in communication with one another such that each prescription that is written by a physician will automatically be characterized as being approved or subject to further authorization, and to the extent authorized, ultimately dispensed to the patient. Moreover, the pharmacy dispensation of the prescribed medication can be done so through a selectively specified pharmacy outlet, whether it be a specific pharmacy, mail order prescription or some other alternative arrangement.

The web-based architecture associated with such system will utilize conventional web-based technology. Specifically, it is contemplated that each of the entities having access to the systems and methods of the present invention will be required to have appropriate authorization and conventional security measures will be implemented to restrict access to the system. In the case of the prescribing physician, the invention manifests itself through a series of steps whereby the physician, after logging into the system, will first elect to prescribe a given drug. Thereafter, the physician will select whether or not such drug falls into one of two main categories, namely, Part D (ambulatory drugs) or Part B (injectable drugs) as characterized by the United States' Medicare healthcare system. The physician will then review the patient's information, current medications and other related detail information, and thereafter can add a further medication to be prescribed.

Once a particular drug is selected, a further determination is made whether or not such drug is included as part of any formulary that may be in place, and to the extent such medication is not within such formulary, whether or not prescribing and dispensing such medication is subject to any prior authorization. The physician will then prescribe those medications deemed appropriate and thereafter the electronic prescription is forwarded to a specific pharmacy and/or a particular health plan or third party payer for prior authorization to the extent warranted. The medication is then ultimately dispensed to the patient at a particular pharmacy or held until authorization is determined. The system also provides health plans/payers to actively upload their electronic formulary into the system thereby providing virtually real-time formulary updates to prescribers.

As for the pharmacist, that entity, too, will log into the systems of the present invention and will be allowed to access each specific prescription as forwarded to the pharmacist. Advantageously, the pharmacist will further be provided with access to medical records and other medical information available to the prescribing physician that can assist the pharmacist in not only dispensing a specific medication, but also to facilitate communication between the pharmacist and physician and to further enhance the pharmacist's role in insuring patient compliance and attaining the therapeutic benefit of the prescribed medication.

From the payer's perspective, such entity will likewise log into the interactive web-based systems disclosed herein and will ultimately make determinations on each and every specific authorization made of the payer with respect to medications that are outside a specified formulary or otherwise require authorization prior to dispensation. For each such prescription, the payer can elect to approve, deny or append authorization requests as may be deemed appropriate. After making such determination, the payer will then proceed to move on to the next authorization.

In all cases, all related parties are in communication with one another and the entire prescription event, from the writing of the prescription, authorization review and ultimate dispensation occur rapidly in real-time. Also, because the parties are in communication with one another, any questions, requests for additional information, and/or any further complications associated with the prescription event can be addressed immediately and promptly by all affected parties.

### BRIEF DESCRIPTION OF THE DRAWINGS

These as well as other features of the present invention will become more apparent upon reference to the drawings.

FIG. 1 is a flow chart depicting the steps performed by a prescribing physician utilizing the systems and methods of the present invention for purposes of prescribing one or more medications to a patient.

FIG. 2 is a flow chart depicting the steps of a pharmacist/pharmacy interacting with the systems and methods of the present invention for purposes of filling a prescription.

FIG. 3 is a flow chart depicting the steps of a third party payer utilizing the systems and methods of the present invention for purposes of approving, denying or holding a prescription pending authorization, as may be appropriate in a given situation.

### DETAILED DESCRIPTION

The detailed description set forth below is intended as a description of the presently preferred embodiment of the invention, and is not intended to represent the only form in which the present invention may be constructed or utilized. The description sets forth the functions and sequences of steps for operating the invention. It is to be understood, however, that the same or equivalent functions and sequences may be accomplished by different embodiments and that they are also intended to be encompassed within the scope of the invention.

The present invention is designed to make the prescription process more efficient, less time-consuming and lead to better outcomes for patients and lower costs for prescribers, pharmacies and health plans/payers. To that end, the present invention integrates every aspect of healthcare—the prescribers, payers, patients and pharmacies—under an easy-to-use online system that allows instant communication to eliminate the temporal inefficiencies and resulting costs that currently plague healthcare.

To accomplish these objectives, the present invention utilizes existing web-based technology whereby multiple entities associated with the administration of healthcare, and in particular those associated with the prescription event, are kept in communication with one another via a conventional web-based communications link. Specifically, it is contemplated that physicians, pharmacists/pharmacies and third party payers, which can be a particular healthcare plan or administrator, will each in their own capacity log into a web-based system whereby each entity will systematically fulfill their role in either prescribing (physician), dispensing the medication (pharmacists/pharmacy) or authorizing (payer).

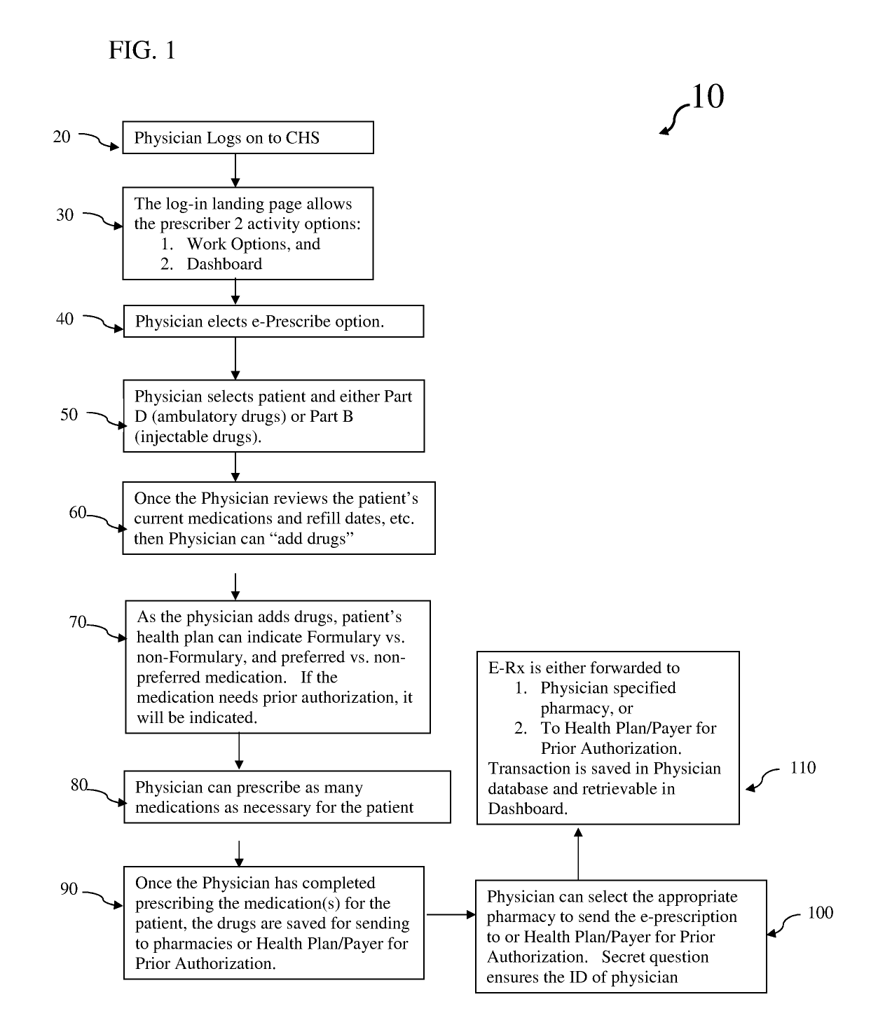

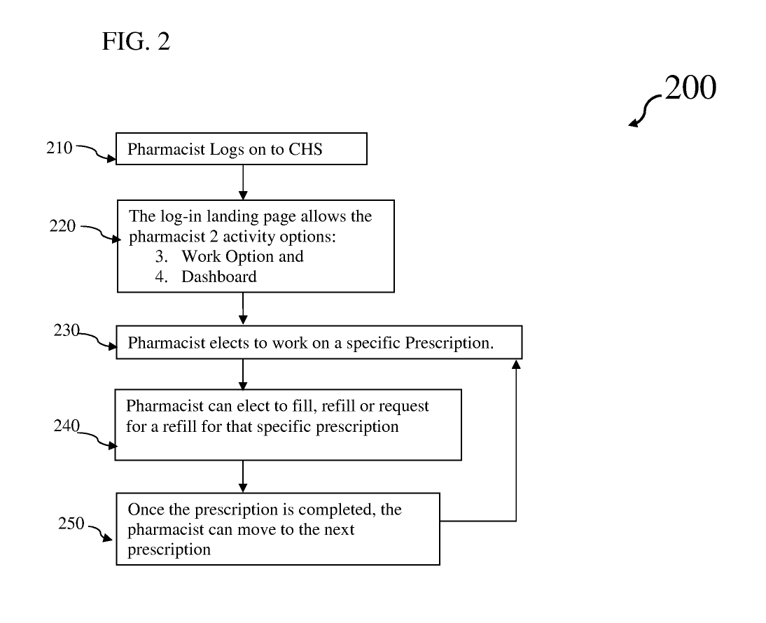

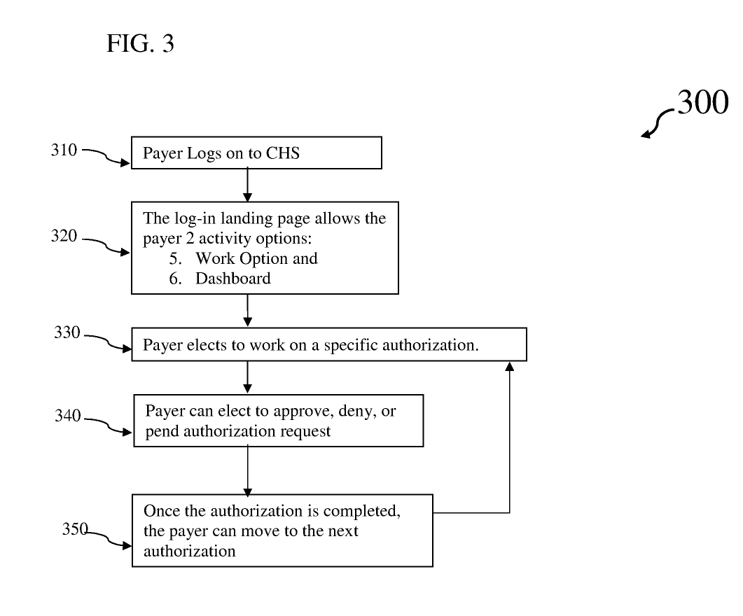

Such systematic approach regarding each of these specific entities is discussed more fully below in connection with the figures. Referring now to the figures, there is shown the systematic steps by which each entity involved in the prescribing event, namely, the prescribing physician that is the focus of FIG. 1, the pharmacist/pharmacy responsible for dispensing the medication in FIG. 2 and the authorizing payer in FIG. 3, will approach each of the duties and obligations in providing a patient with one or more medications to treat a particular condition. With respect to the prescribing physician featured in FIG. 1, such physician will proceed through the systematic process 10 by performing the following sequential steps.

Initially, the physician will log onto the home page of the interactive web-based e-prescription system of the present invention. The web-based system, referred to herein as CHS (Cooperative Health Solutions), at step 20. As per conventional web-based access technology, it is contemplated that the physician's ability to log on to the web-based system will be conditioned by conventional security measures, such as password protection and other known techniques readily available and practiced by those skilled in the art.

In step 30, the log-in landing page has 2 activity options for prescribers: 1) Work options, and 2) Dashboard “Work options” include tabs that direct to the e-Prescribe, admin setting, etc. pages. To make a prescription, the physician elects the “e-Prescribe” tab/option at step 40. From here, the prescriber at step 50 will select a patient and a window will appear detailing the patient's known allergies, past medical and prescribing history, current medications and refill dates, and other pertinent information. This gives the prescriber a full account of the patient's current and past condition, instead of having to rely on the patient's (sometimes faulty) memory. When a physician electronically prescribes through our platform, they also have the ability to choose and prescribe—unlike other e-prescribe systems—either Part D (ambulatory) or Part B (injectable) drugs (most e-prescribe systems only manage Part D drug prescriptions).

Once the physician has finished reviewing the patient's file, he/she will click on “Add Drugs” to originate the prescription per step 60. As the physician adds drugs, he/she will have many more options other prior art e-prescribe systems do not offer. For example, health plans can pre-upload their formularies into our platform, allowing physicians to know instantly whether or not a drug is formulary vs. non-formulary, or preferred vs. non-preferred, instead of having to find out retrospectively. Our system also allows prescribers, per step 70, to instantly know if a medication needs prior authorization, preventing the unnecessary time lag of having a prescription first sent to a pharmacy only to find out that it needs prior authorization, making the pharmacy responsible for contacting the health plan to obtain prior authorization, etc. Advantageously, step 80 allows a physician to prescribe as many medications as necessary for the patient. With CHS, the physician will also be able to access all of a patient's medical documents and records, which notifies the prescriber what allergies the patient may have, what other medications he/she has taken, past medical conditions, etc.

Once the physician has completed prescribing the medication(s) for the patient, the drugs are saved for sending to pharmacies or health plan/payer for prior authorization at 90. Instantly knowing whether or not a drug requires prior authorization can easily save weeks of potentially wasted time where a prescription could go proceed from the prescriber to the pharmacy (where they would figure out a drug actually requires prior authorization) to the health plan (for prior authorization) to the pharmacy to the patient. With CHS, a prior authorization actually becomes a prior authorization instead of a retrospective authorization, saving all parties' time, and delivering care to patients more efficiently. Physicians can then select at 100 the appropriate pharmacy to send the e-prescription to or health plan/payer for prior authorization if necessary. Along with which drugs are part of a patient's health plan formulary and which drugs are preferred, prescribers will also be able to access details such as which pharmacies are preferred within a patient's health plan network. Optionally, to ensure security, a secret question can be used to confirm the ID of a physician before sending out the e-prescription (e.g. What is your favorite food?) Finally, at step 110, the E-Rx is either forwarded to 1) the physician specified pharmacy, or 2) to the health plan/payer for prior authorization.

The transaction is saved in the physician's database and is retrievable in his/her Dashboard. The transaction is also logged in a patient's account/file, allowing prescribers to better keep track of all interactions, problems addressed, medications prescribed, health plan/group, etc.

Referring now to FIG. 2, there is shown a process 200 that outlines the sequential steps by which a pharmacist/pharmacy will utilize the web-based system to systematically dispense a medication prescribed by a physician per the sequences discussed above with respect to FIG. 1. Initially, the pharmacist logs on to CHS per step 210. As discussed above, it is contemplated that the web-based interactive systems of the present invention through which the methods are practiced will implement known, existing security measures to restrict access to only those individuals that are authorized.

Once logged in at step 220, the log-in landing page allows the pharmacist two activity options: 1) Work Option and 2) Dashboard. The Work Options include prescriptions, admin setting and the Dashboard allows the pharmacist to perform various tasks. The pharmacist elects to work on a specific prescription at 230. For example, say a new prescription has come in from a physician, the pharmacist will immediately be notified on his/her Dashboard of the newly received prescription. Once opened, the pharmacist will be able to review/see all of the patients allergies, past medications taken, whether or not the patient has had refills on the drug(s) prescribed, and any prior authorization forms (from the payer, if applicable). The pharmacist can then elect to fill, refill or request for a refill for that specific prescription at 240. Once the prescription is completed, the pharmacist can move to the next prescription at 250, whereby step 230 can again be performed.

Referring now to FIG. 3, there is shown a further sequential process 300 by which the payer involved in authorizing prescribed medications sought to be dispensed through the methods of the present invention will utilize the interactive, web-based system for reviewing and ultimately determining whether or not a particular medication is dispensed to a particular patient.

As illustrated, the payer initially logs on to CHS per step 310 and once logged in at step 320, the log-in landing page allows the payer two activity options: 1) Work Option and 2) Dashboard. The Work Options for payers include processing of authorizations, admin setting, and the Dashboard. The payer then elects to work on a specific prior authorization request at step 330. On CHS' Dashboard, the payer has easy access to such requests and is immediately notified when new requests are received. Upon opening a prior authorization request, the payer can elect to approve, deny, or pend the authorization request at step 340. Using CHS, prior authorization requests will come straight from the prescriber, and NOT retrospectively after the pharmacist realizes after having received a prescription that a prior authorization is necessary. This is because CHS' unique platform will notify prescribers while writing a prescription which drugs require prior authorization from the payer. Other such platforms only allow prescribers to electronically send prescriptions to pharmacists, making pharmacists have to send back prescriptions that need prior authorizations to payers, further delaying efficient healthcare delivery to the patient. Finally, at step 350, once the authorization is completed the payer can move to the next authorization. The authorization is then sent with the prescription to the payer's preferred pharmacy without any delays.

In this regard, conventional modes of telecommunication are deployed to keep all such entities in communication with one another, such as by instant messaging, email or any other known methods via a global computer network that will facilitate—if not force—each entity (i.e., physician, pharmacist and payer) to have knowledge and awareness of all aspects of a prescription event. As a consequence of the present invention, doctors can now concurrently prescribe all the medications necessary for a medical regimen while instantly finding out whether or not the pharmacy they are sending the prescription to is able to fill all the prescriptions. After getting a prior-authorization, payers can then easily send all the prescriptions of a treatment together to a single pharmacy to avoid any confusion.

Advantageously, the present invention is specifically designed to not only utilize existing web-based telecommunications technology to link all affected parties to one another, but also is operative to allow to a systematic approach by which all types of prescribed medications, whether they be Part D or Part B drugs as designated by the United States' Medicare healthcare administration system or otherwise consistent with a particular formulary whereby drugs are characterized as either preapproved or not approved. The present invention further facilitates the ability by which a particular medication that may not be a formulary approved medication can undergo authorization review whereby such medication is either approved, denied or kept in pending status until the authorization review is complete.

By virtue of the integration of all entities associated with the prescription event, coupled with the fact that each such entity is involved in an interactive, web-based system, significant advantages exist over currently available electronic prescription systems. For example, the present invention enables real-time notification to the extent a particular drug requires authorization. Moreover, prescribing physicians will have access to when prescriptions are completed by the pharmacy, and prompt—if not instantaneous—confirmation of formulary verification.

The following table illustrates the major critical differences between currently available prior art programs and that of the present invention.

TABLE 1

| | Prior Art e-Prescribe | The Present |
|---|---|---|
| Feature | Systems | Invention |
| Can manage Part D drugs | Yes | Yes |
| Can manage Part B drugs | No | Yes |
| Real-time notification if drug requires prior | No | Yes |
| authorization | | |
| Ability to allow health plans/payers specific | No | Yes |
| formulary downloaded straight from payer | | |
| Formulary verification going through a third | Required | Not necessary |
| party. This normally requires additional fees | | |
| Formulary verification specific to a patient's | Must go through third | yes |
| insurance program | party requiring additional | |
| | fees | |
| Option for health plans/payers formulary to | No | Yes |
| direct to specific drug through the use of NDC | | |
| Option for health plans/payers to provide generic | No | yes |
| drug based formulary | | |
| Option for health plans/payers to deliver direct | No | yes |
| communications to prescribers and pharmacies | | |
| based on a patient's specific insurance program | | |
| Options for health plans/payers to direct specific | No | Yes |
| medication to specific pharmacies | | |
| Options for health plans/payers to direct specific | No | Yes |
| medication based on specific prior authorization | | |
| criteria | | |
| Communication between prescriber/doctor and | Some electronic | Yes |
| pharmacy | prescription programs, | |
| | not all. Typically use a | |
| | third party | |
| Communication between prescriber/doctor and | No | Yes |
| payer | | |
| Communication between pharmacy and payer | No | Yes |
| Doctors have access to when the prescriptions | Some electronic | Yes |
| are completed by the pharmacy (compliance | prescription programs, | |
| | but not all. Typically use | |
| | a third party | |
| Health plans/payers can keep updated file of | No | Yes |
| preferred drugs—brand and generics | | |
| Health plans/payers can switch a prescription to | No | Yes |
| a preferred pharmacy even after prescription | | |
| leaves doctor's office | | |
| Patients and doctors can also change/switch to a | No | yes |
| different pharmacy even after prescription leaves | | |
| doctor's office | | |
| Patients, health plans/payers, doctors and | Some electronic | |
| pharmacies can all communicate directly with | prescription programs, | |
| one another. | but not all. Typically use | |
| | third party. | |

Even though the present invention is an e-prescribe platform of sorts, it differs at multiple facets of functionality that allow it to achieve a much more comprehensive level of efficiency while still managing to deliver high quality of treatment. First off, typical e-prescribe processes available are only able to manage Part D, but not Part B (specialty injectables) drugs; already, this limits these prior art platforms' abilities from including 45% of prescribed drugs.

The present invention platform also differs in that formularies that are specific to different health plans can be downloaded from payers directly; other e-prescribe systems only have basic formularies that are used for the entire health plan, meaning doctors have to go through some third-party interchange to acquire the appropriate formulary for a specific plan (i.e. more steps that take more time, and raise the chances for mistakes to be made). Specifically, the interactive web-based prescription system and method of the present invention identifies a “Prospective Formulary Determination” (PFD) “import” process that enables an insurance company to upload its formulary into the system and allows the prescriber to access, in real-time, the most current formulary selections based on a patient's payer/insurance group or type.

The PFD allows the following features for the insurance to: 1) Import varying formularies based on a particular Group Code/ID to provide a granular determination based on a patient's specific benefit; 2) import as many formularies on a weekly basis for as appropriate based on the needs of the insurance payer; 3) have the ability to communicate with the prescriber when a non-formulary drug is requested, i.e., formulary alternatives, copay alternatives; and 4) have the ability to allow prescriber to perform prior authorization process before the patient takes the prescription to the pharmacy. These features provide the most up-to-date formulary decisions and information an insurance payer wants to communicate to a prescriber based on the patient's benefit plan.

The PFD also allows the following features for the prescriber to: 1) access formularies based on a particular Group Code/ID to provide a granular determination based on a patient's specific benefit; 2) real-time access to the latest formulary information; 3) have the ability to identify formulary alternatives in order to help patient stay on formulary and copay tiers; and 4) have the ability to allow prescriber to perform prior authorization process before the patient takes the prescription to the pharmacy. These features provide the most up-to-date formulary decisions and information from an Insurance payer based on the patient's benefit plan.

The PFD allows the following features for the patients and pharmacies and manufacturers to: 1) access formularies based on a particular Group Code/ID to provide a granular determination based on a patient's specific benefit; 2) verifying formulary status of medication based a patient's benefit plan; and 3) verifying formulary copayment status of medication based a patient's benefit plan. These features provide the most up-to-date formulary decisions and information from an insurance payer based on the patient's benefit plan.

Unlike all other e-prescribe processes that establish one-way communication between the doctor and pharmacy; the present invention, in contrast, allows multi-way communication between the doctors, patients, and payers to allow optimal cooperation and ideal efficiency in healthcare delivery. The processes disclosed herein thus eliminate the need for third-party intermediaries and instead integrate all communication of information (whether it be drugs included on the formulary, patient allergy profiles, etc.) into a central platform. This allows doctors/patients/payers to change pharmacies at multiple points after a prescription leaves the doctor's office (whereas with other systems, once a prescription is sent to a pharmacy, this choice of pharmacy is locked down after that initial decision). For example, a prescription can be redirected by a payer (after leaving a doctor's office) based on preference and/or risk level. A prescription can also be redirected after leaving a doctor's office directly to a payer if prior authorization is needed, instead of having to wait for retrospective redirection after having reached the pharmacy already. Doctors are thus given the ability to see exactly the dates and times a patient had their prescription refilled, allowing doctors a way to verify if the prescription is simply not working or if the patient has not been compliant. This is one aspect in which the present electronic prescribing system seeks to provide better ways to keep track of patient compliance, which is considered one of the biggest healthcare problems today.

Indeed, current pharmacy practices and the manner by which prescriptions are filled are poorly suited to provide any kind of measure as to whether or not a prescribed medication is achieving any kind of degree of improved healthcare. For example: a patient with high blood pressure is given a prescription and does not fill it; later when his doctor asks if he has been taking his medication, if the patient lies and says he has been and the doctor finds his blood pressure to be just as high as before, it could lead to many potentially dangerous results. The doctor may think the prescription is not working and increase the dosage and/or add another medication on top of the original prescription, which can ultimately lead to hazardous results as well as waste.

The present invention overcomes these deficiencies by electronically facilitating the prescription event whereby the primary entities, namely, the prescribing physician, pharmacy/pharmacist and third party payer, cooperate via one integrated system in seamlessly prescribing and filling prescriptions subject to payer approval. Moreover, the present invention can readily be integrated with this country's Medicare system, and in particular both Part B and Part D pharmaceuticals, and is likewise extremely user friendly, capable of being operated on existing web-based technology, is substantially cost effective and is further operative to better insure patient compliance and actually improve patient health via greater oversight and improved patient compliance.

To that end, the present invention differs from other e-prescribe systems and platforms because it works on multiple levels of functioning, whereas others primarily focus on the basics of delivering prescriptions (only for Part D drugs) to pharmacies. On the other hand, the present invention offers prescribers crucial factors that can affect their ultimate prescribing choice/decision such as whether or not a drug is included in a patient's plan's formulary, as discussed above, and whether or not a drug requires prior authorization, etc. This can prevent a prescription from having to bounce around from prescriber to pharmacy to payer to pharmacy (and on and on) before finally achieving the ultimate goal: treating the patient. For instance, if a drug requires prior authorization by the payer, the prior authorization form will automatically show up/be available while the doctor is writing up the prescription; this prevents the inefficiency presented if that prescription were to first go the pharmacy, at which point the pharmacists will realize the drug needs prior authorization, have to wait to send the prescription to the payer who will then authorize the drug or not, etc. Along with these choices prescribers will also have ready access to a patient's previous medical/prescribing history, allergies, which drugs are preferred in their plan, and many more that will also cut down unnecessary time lags and chances for error. Therefore the methodology of the present invention goes beyond basic e-prescribe processes by allowing personalized and flexible healthcare that ensures the patient receives the highest quality of healthcare efficiently.

Additional modifications and improvements of the present invention may also be apparent to those of ordinary skill in the art. Thus, the particular combination of parts and steps described and illustrated herein is intended to represent only certain embodiments of the present invention, and is not intended to serve as limitations of alternative devices and methods within the spirit and scope of the invention.

What is claimed is:

1. A process for implementing an electronic prescription and dispensing a medication in response thereto, subject to prior authorization, the process comprising the steps:
a. providing a web-based communications link between a physician responsible for writing a prescription, a pharmacy operative to dispense a medication in response to said prescription, and a payer responsible for authorizing the dispensation of said medication by said pharmacy pursuant to said prescription;
b. generating a prescription by said physician in step a) and transmitting said prescription electronically to said pharmacy and said payer in step a);
c. reviewing said electronic prescription for authorization, said review being conducted by said payer;
d. authorizing or denying said electronically transmitted prescription; wherein
e. upon authorizing said prescription in step d), said pharmacy dispenses said medication in response said electronic prescription and upon denying said prescription in step d), said pharmacy is denied from dispensing said medication in response to said prescription.

2. The method of claim 1 wherein in step b), said prescription is for a medication having a designation selected from the group consisting of Medicare Part B and Medicare Part D.

3. The method of claim 1 wherein: in step a), there is further provided a formulary identifying a list of medications pre-approved by said payer; wherein in step b), said prescription is for a medication listed upon said formulary provided for in step a); wherein in step d), said payer automatically approves the dispensation of said medication; and wherein in step e), said pharmacy dispenses said medication.

4. The method of claim 1 wherein: in step a), there is further provided a formulary identifying a list of medications pre-approved by said payer; wherein in step b), said prescriptions for medication not listed upon said formulary provided for in step a); wherein in step d), said payer automatically denies the dispensation of said medication; and wherein in step e), said pharmacy is denied from dispensing said medication.

5. The method of claim 1 wherein step a) further comprises the step of providing medical data associated with a patient for which said physician prescribes said medication; and wherein in steps b) through e), said patient information is disseminated and made accessible to said prescribing physician, said pharmacist and said payer.

6. The method of claim 5 wherein in steps a) through e), said prescribing physician, said pharmacist and said payer are kept in communication with one another via a communication mode selected from the group consisting of instant messaging, text messaging and email.

7. The method of claim 3 wherein in step a), said formulary is uploaded to a database accessible to said physician, said pharmacy and said payer.
